(19) United States
(12) Patent Application Publication
(10) Pub. No.: US 2002/0099636 A1
(43) Pub. Date: Jul. 25, 2002

(54) Computerized method, process and service for stock investment timing

(76) Inventor: Timo J. Narumo, Espoo (FI)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/725,112

(22) Filed: Nov. 29, 2000

(51) Int. Cl. G06F 17/60

(52) U.S. Cl. 705/36; 705/26

(57) ABSTRACT

The invention is in the field of using a computer implemented method to calculate and provide recommendations for stock share investment timing. The process gathers price and volume data of listed firms from as many stock markets as implemented, only condition being that those markets price data are available over the Internet, in order to be able to automate the process. Analysing and calculation methods used within the process differ from those used in typical technical stock analyses in that the invention takes advantage of the known price history and uses statistical mathematics to categorize the current price to a recommended action: ‘sell’, ‘buy’ or ‘hold’, while the most famous technical analysing methods typically try to predict the share price in the near future. The clear benefits of the process are that, after being set up properly, the process does not need human intervention, except in rare special cases, and furthermore, the calculated results are very easy to interpret even by persons without much experience in stock investing. Performance statistics clearly show that remarkable increase in profit of stock share investments can be gained by using the recommendations. The method has been implemented in a form of WWW-service and it is usable globally via the Internet. The method has been donated as StockMapper.

### FIELD OF THE INVENTION

The invention relates generally to the field of stock investment timing management. More particularly, the present invention relates to a computerized method for supporting stock inventors in the decision making process, including a calculation process for obtaining daily recommendations (as buy, sell, hold) for all listed securities of all stock markets accessible via the Internet inventors as well as a method of making the same available to stock investors.

### BACKGROUND AND OBJECT OF THE INVENTION

Interest toward investing to stock shares has increased rapidly worldwide during 1990's. This has caused that masses of people would like to have a means to filter out the meaningful information from the enormous volume of stock price data available nowadays. Manually that is more or less an impossible task because of high number of firms listed in a typical stock market. In order to tackle this problem, an invention to filter out and take advantage of small variations (volatility) in the stock share prices is by the present invention presented.

Perfect market timing is in stock investments an adored goal but without insider information of the firms it is considered as very difficult or impossible thing to succeed. Plenty of technical analysing methods exist that have a common basis: they try to predict the share price in the near future like the ones utilizing theories of neural networks, like e.g. in U.S. Pat. No. 5,761,386. However, stock market price data hardly follow any known mathematical or technical theory because they are heavily dependent on psychological phenomena e.g. sometimes caused by mass hysteria of the investors as feedback to some surprising stock bulletin.

Another drawback of known technical analyses systems is that, though it can give a plenty of information or pseudo information, it typically requires heavy human interaction to interpret the calculated figures. This does not help to solve the original problem abundance of stock market information available, any further.

It is an object of the present invention to provide for a new, stock investors supporting method which is readily usable for making a buy/sell decision preferably having the ability of easily calculation with an individual risk profile, and obviating at least part of the disadvantages of the known methods. It is a further object of the invention to provide a service which runs the process daily for at least one of all the major stock exchanges in the world. The invented method differs from the known methods in that it takes advantage of the known history of the share price and compares the current price to the history from statistical mathematics point of view. This enables categorizing the share current price into three different classes: high (sell), moderate (hold) and low (buy). Still, although perfect market timing cannot be promised, also not by using the recommendations of the method according to the invention, the least achieved by using the new method is that bad timings, e.g. to buy with the peak expensive price or to sell with the lowest possible price, are not anyhow possible at least are now revealed in a very favourable and understandable manner. Moreover, the new method renders it highly probable to achieve a considerable improvement to the investment gains in the long run.

The new method eases market timing, viz. when to buy or sell which shares. In a relatively readily understandable manner closely associated with comparing actual share price is buy and sell limits derived from historical data analysis based on a new philosophy utilising probability calculations from the wavelength field.

### SUMMARY OF THE INVENTION

The present invention, donated as StockMapper, aids in solving the problem of an investor to determine a good timing for his stock investments. This is achieved with a computer program that implements the method of gathering stock share price and volume data from different stock exchanges over the Internet, appending the data to the existing database on the server, modelling the data of each security to a probability distribution and determining confidence intervals for the security price by statistical mathematics to categorize a recommendation ‘buy’, ‘sell’ or ‘hold’. This is repeated daily for all the securities of all selected stock exchanges.

The current implementation of the method consists of a WWW-server visible to the global Internet. Clients who want to utilize the recommendations in their investments, can use the service from any location having a computer with a WWW-browser and an Internet connection.

### DESCRIPTION OF THE DRAWINGS

FIGS. 1A and 1B represent a mapping of share price data onto a probability distribution.

FIG. 2 is a screen shot from StockMapper website: example of daily updated table with recommendations and other information for the securities.

FIG. 3 is a screen-shot from StockMapper website: example of daily updated figures for the securities; high risk profile.

FIG. 4 is a screen-shot from StockMapper website: example of daily updated figures for the securities; low risk profile.

FIG. 5 is a screen-shot from the current (StockMapper) website service providing an example of a daily updated performance statistics table.

FIG. 6 is a schematic representation of the service as provided over the Internet.

### DESCRIPTION OF THE INVENTION

The following sections describe the generic model of the process. All the actions are supposed to take place within a WWW-server computer harnessed for this purpose if not otherwise stated. Also, the same steps for an existing implementation in practise are described.

In this description the following abbreviations as commonly known in the field are utilised:

| | | |
|---|---|---|
| HEX | = | Helsinki Stock Exchange; |
| HTML | = | HyperText Markup Language; |
| P-value | = | Value as percentage of cumulative probability |
| | | distribution for a random variable; |
| TCL | = | Tool Command Language; |
| URL | = | Unified Resource Location; |
| WWW | = | World Wide Web. |

### Automation of the Process for a Series of Securities

A computer based timer process has been created which runs a series of actions described in the following with predetermined frequency, preferably daily.

The series of actions as described below for all predetermined securities e.g. for all the securities listed in HEX.

### Model for Performing the Series of Actions for a Single Security

The stock price information from the Internet is downloaded in a raw format to the server. More exactly, the data of the most current stock day are downloaded. Typical data contains ticker or abbreviation for the security, open price, highest price, lowest price, close price and volume of the day.

The information is parsed into useful numeric data for calculation. After this parsing the most current data is in a desired format for the calculation.

The data to previously gathered data files which contain one row of data per date are appended.

The history window W to be used is determined by using spectral analysis based on Fourier transform known per se. The meaning of this procedure step is to optimize the interval over which data is taken into account in the actual probabilistic calculation. Generally, if the share price under consideration has rapid, like daily fluctuations of bigger amplitude than the longer period changes, this procedure step will lead to a relatively short history window. On the other hand, if the price data is smooth in that price changes over long period are clearly bigger in amplitude than daily or other short period changes, the procedural step will result in a relatively long history window W. This ensures that the probability distribution estimation that will follow this step is performed over as representative period as possible.

In detail this step is performed as follows:

The biggest number n for stock days to be taken into account for which 2ⁿ is less than the number of available data in stock days is determined.

The effective security price is determined for each of these chosen stock days, using a binomial distribution to model a simple, though practically sufficiently effective and meaningful price distribution within a stock day. E.g. if each of open, close, highest and lowest prices are available, effective price P_{eff} for a day will then be

$${P}_{eff} = \frac{1}{8} ( {P}_{lowest} + 3 {P}_{open} + 3 {P}_{close} + {P}_{highest} ) \qquad ( 1 )$$

If all of these prices are not available then only available prices and a lower order binomial distribution will be used, respectively.

Calculate Fourier transform by Fast Fourier Transform method for n most current stock days using effective day prices P_{eff,i}, and i=1,2, . . . n. The result is a series of n complex numbers p_{eff,i} which are used to calculate the power spectral density PSD of the effective prices, viz.

PSDᵢ=|p_{eff,i}|

where |z|=x²+y² means the length (or 2-norm) of complex number z=x+iy.

The components of the power spectral density PSD describe the relative amplitudes of frequency components corresponding to wavelengths n, n/2, n/3, . . . in effective prices. The biggest of these, denoted by PSDₘₐₓ=PSD(nₘₐₓ), is taken in condition that nₘᵢₙ≦nₘₐₓ≦n/2, where nₘᵢₙ is a minimum number for accepted history window, viz. a minimum sample size that is accepted for probability distribution estimation and n/2 is the chosen upper limit, which ensures that the most dominant frequency has appeared in the data at least over two whole wavelengths. For the man skilled in the art of statistics, it is evident that in practice, this means that e.g. a cyclical behaviour of one year wavelength is not accepted as the dominant wavelength if less than two years of price data is available. The reason for this condition is that calculated cyclical behaviour over one wavelength cannot be considered as any proof that the behaviour is really cyclical with that frequency in the future, but it might have taken place by chance. However, calculated cyclical behaviour over the period of two or more wavelengths is much more probable proof of a real phenomenon.

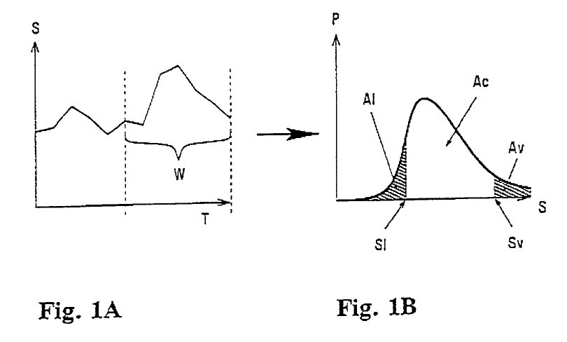

The data of the chosen history window W as depicted in FIG. 1A is molded onto a suitable probability distribution like in FIG. 1B. In FIG. 1, S denotes share price, T denotes time, W denotes the interval of the history window to be taken into account as determined by the computer program, P denotes the probability factor of the occurance of a share price S, whereas Sl and Sv denote the limiting share prices between “buy” and “hold” regions in graph 1B and between “hold” and “sell” respectively. Ac denotes the area of confidence, e.g. 68.5%, i.e. the “hold” region, Al denotes the lower limiting area, e.g. 15.75%, i.e. the region to “buy”, whereas Av denotes the upper limiting area, e.g. 15.75%, i.e. the region of sell.

The Gamma distribution is according to the insight underlying the invention taken as the best choice for a ‘normally’ behaving viz. like variables following Gaussian distribution. However, the Gamma distribution is a difficult one for numerical calculations and thus, in the current method the Gaussian distribution is utilised as an acceptable alternative. The Gaussian distribution is symmetric and extends over the real number axis thus including negative numbers, which might sound like disadvantages when used to model stock price data. In the current method, advantage is taken from the circumstance that the Gaussian distribution approaches asymptotically the symmetric Gamma distribution when the deviation is small compared with the mean of the distribution. Namely, this is the case with typical stock price data: deviation (volatility) is small compared with the time-average value. If this were not the case, the security would have suffered from an abrupt and heavy decrease or undergone a quick positive multiplication in value, which situations are generally rare and very difficult to tackle with any mathematical algorithms sensibly. Because of these reasons, it is taken into the invention that the Gaussian distribution in the current application works virtually identically with Gamma distribution in the circumstances where the base of the method is strong and makes more difference only in the cases where already the basic idea behind the algorithm doesn't work particularly well. In conclusion, the Gaussian distribution can be safely used in the practical calculations for the method according to the invention.

The estimation onto Gamma distribution is performed as follows:

Definition: a random variable X with cumulative density

$$F ( x ) = \frac{1}{Γ ( α ) {β}^{a}} {\int }_{0}^{x} {z}^{α - 1} {ⅇ}^{- z / β} ⅆ z , x > 0 , α > 0 , β > 0 \qquad ( 3 )$$

is said to have a gamma distribution with parameters α and β. Here ┌(α) is the Gamma function defined by

$$Γ ( α ) = {\int }_{0}^{∞} {z}^{α - 1} {ⅇ}^{- x} ⅆ z \qquad ( 4 )$$

Theorem: Let X be a gamma random variable with parameters α and β. Then

Expected value E[X]=αβ

Variance VarX=αβ²

By calculating volume weighted mean and variance of the effective share price data P_{eff,i}, the parameters α and β can be solved from the previous equations. These parameters fix the distribution in an unequivocal way. The weighting by daily volume adds sensitivity to the algorithm: data of high volume days are more meaningful than data of low (or even null) volume days. Also, rapid changes in share price correlate with high volume, which means that the algorithm is the most sensitive just within the periods of the most abrupt changes of the price.

The estimation onto Gaussian distribution is performed as follows:

Definition: a random variable X with cumulative density

$$F ( x ) = \frac{1}{\sqrt{2 π} σ} {\int }_{- ∞}^{x} {ⅇ}^{- \frac{1}{2} {( \frac{x - ρ}{τ} )}^{2}} ⅆ z , - ∞ < x < ∞ , - ∞ < μ < ∞ , σ > 0 \qquad ( 5 )$$

is said to have a normal or Gaussian distribution with mean μ and variance σ².

By calculating volume weighted mean and variance of the effective share price data P_{eff,i}, the parameters of Gaussian probability distribution are directly solved and the distribution is fixed unambiguously. The volume weighting is used because of the same reason explained in the case of Gamma distribution above.

The P-value of the most current effective share price P_{eff} is calculated, viz. the location of current price on the estimated cumulative probability distribution, and confidence limits of predetermined risk level α, i.e. limits for recommendations to sell or buy, from the probability distribution.

The risk level α is a matter of choice. A low chosen risk level would mean strict conditions for the calculation to result in the recommendations ‘sell’ or ‘buy’. Respectively a high risk level would lead the calculation more easily to those recommendations. For a long time average, the chosen risk level describes the portion of days which are labelled with the recommendation ‘sell’ and the same portion with the recommendation ‘buy’. Thus, the risk level can be fixed to a decided value, or it could be optimized according to a simulated sliding investing period reaching from the current day backwards. Then transactions would be simulated to be performed according to the already calculated recommendations and the criteria for optimization would be to choose the risk level that maximizes profit over the period. This would add a feedback process to the determination of risk level.

In detail, for a fixed risk level α and in the case that the Gamma distribution is used, the following steps are performed:

Calculate the P-value of P_{eff} from the cumulative Gamma density function utilising a commonly available numeric recipies e.g. with the ideas of W. N. Press et al. in “Numerical recipies in C” published by Cambridge University.

Compare the P-value to the chosen risk level α such that

if P-value<α, the recommendation will be ‘buy’.

if P-value>100%-α, the recommendation will be ‘sell’.

if α≦P-value≦100%-α, the recommendation will be ‘hold’.

Calculate the values for the random variable (i.e. the share price) that have the probabilities a and 100%-α in the estimated cumulative probability distribution. To perform this, a numerical way to calculate inverse of cumulative Gamma density function, Eq. (3), is needed. This can be implemented in accordance with commonly known numerical recipies, e.g. from the previously mentioned numerical handbook in accordance with ideas of W. N. Press et al. in “Numerical recipies in C” published by Cambridge University. These values are the limiting share prices between ‘buy’ and ‘hold’ regions, and between ‘hold’ and ‘sell’ regions.

Respectively, for a fixed risk level α and in the case that the Gaussian distribution is used, the following steps are performed from the previously mentioned numerical handbook:

Calculate the P-value of P_{eff} from the cumulative Gaussian density function, Eq. (5), numerically.

Compare the P-value to the chosen risk level α such that

if P-value<α, the recommendation will be ‘buy’.

if P-value>100%-α, the recommendation will be ‘sell’.

if α≦P-value≦100%-α, the recommendation will be ‘hold’.

Calculate the values for the random variable, i.e. the share price, that have the probabilities α and 100%-α in the estimated cumulative probability distribution. To perform this, a numerical way to calculate inverse of cumulative Gaussian density function, Eq. (5), is needed. Implementation is done with commonly available numerical recipies, e.g. from the earlier mentioned numerical handbook. These values are the limiting share prices between ‘buy’ and ‘hold regions, and between ‘hold’ and ‘sell’ regions.

Print out the calculated results as the P-value, recommended action, i.e. ‘sell’, ‘hold’ or ‘buy’, and the limiting share prices in a desired format. In addition, save the limiting share prices in order to be able to produce a series of those limits as curves over time.

### Example Implementation of the Generic Model Utilising an Existing WWW-Service

The Helsinki Stock Exchange (HEX) last closed information of all listed securities from the URL of HEX website or other available stock price data provider is downloaded after each stock day. The information is typically in unsuitable format for numerical calculation in this phase and it is denoted as being in a raw format, typically in HTML format.

The raw data is converted into suitable numeric data for calculations by a parser function suitable for HEX. This involves string manipulations commonly known and available from handbooks.

The data are appended to the previously gathered files which exist one per security. This is e.g. performed by a simple append function, implemented in TCL.

The following steps are repeated for each security.

The dominating frequency component is determined from the price data and use the corresponding wavelength, i.e. period, as the history window for the security.

The preferred implementation of the service according to the invention defines two investor profiles: of high and low risk investor. However, finer discriminations of risk profiles may be readily implemented utilising the principles provided by the current example. For the high risk investor profile, the history window is set to be the wavelength of the most dominant frequency component between two weeks and three months (or one quarter of a year which is an important period for stock companies because of their quarterly financial announcements). The lower limit being two weeks is a practical limit in order to have a reasonable sample of at least 10 data points to estimate a continuous probability distribution. For the low risk investor profile, the history window is set to be the wavelength of the most dominant frequency component between three months and half of the maximum period of available data (to make sure that the most dominant cycle has been there at least over the period of two whole wavelengths). In practice, the division into two investor profiles means that a client can choose between recommendations produced by a less sensitive, in their words “a low risk”, and a more sensitive, “high risk”, algorithm. As the described methods for determining the history window imply, in the high risk profile algorithm share price variations and volatility over short period are taken advantage of, while in the low risk profile algorithm share price changes over longer periods are utilized.

The volume weighted sample mean and standard deviation is calculated from the data for the security over the previously determined history window backward from the most current data item. This is here implemented with functions from TCL. By using the mean and standard deviation, the Gaussian probability distribution behind the data is determined, which is virtually done already by knowing the mean and standard deviation.

The estimated distribution is used to calculate the P-value of the most current share price and confidence limits with risk level α=10% which define the limits between ‘sell—hold’ regions and ‘hold—buy’ regions. Determine the recommendation according to the P-value as was described more generally here above.

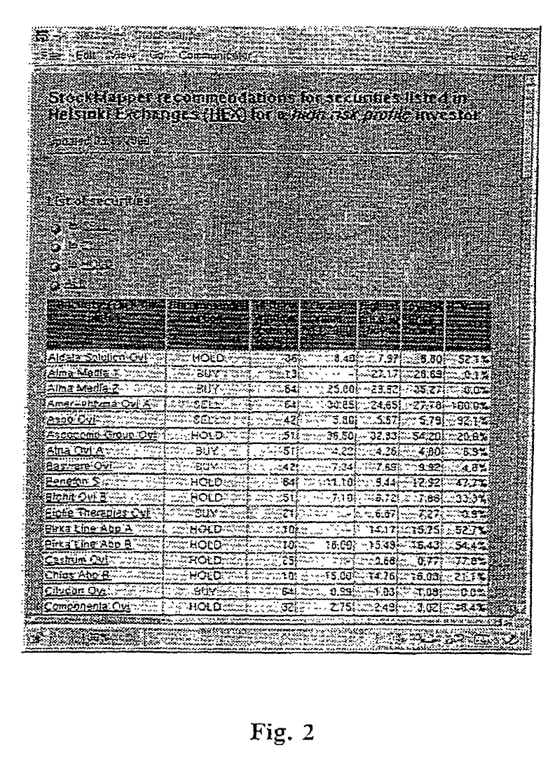

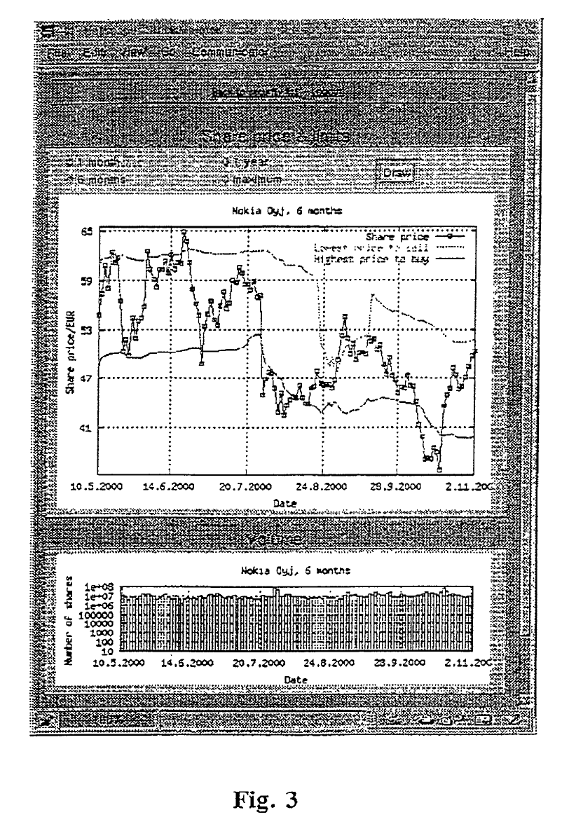

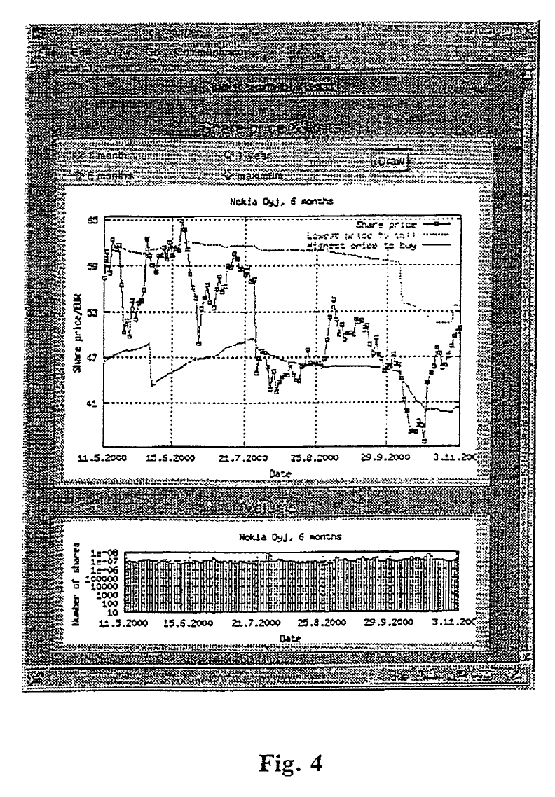

The results are printed in HTML format such that finally a table for each investor profile (low risk and high risk), containing all the securities and the history window, recommendation, last close price, limiting prices and P-value for each security is composed. An example screen-shot is shown in FIG. 2. In addition, compose figures of the share price, limiting prices for the recommendations and volume over different periods, e.g. for the previous month, 6 months, 1 year and for maximum available period. These figures can be viewed by the service user through the security name in the table which provides a link to the WWW-page containing the figures. Example screen-shots of those figures for both high risk investor and low risk investor profiles are shown in FIGS. 3 and 4.

The implemented service is fully automatic, which is achieved by an arrangement in which:

The used server computer stays always in power-on state.

The used server has a permanent broadband Internet access in order to be able to serve as many clients simultaneously as possible.

The implementation is realised rather fast with an ordinary personal computer that is set up to be a server. Usually the slowest step is the downloading of the raw data from the Internet, as previously explained. This takes at least many seconds, though depending strongly on the format and size of the data to be gathered. That varies a lot between different stock markets, Internet services and stock data providers.

The steps for filtering out meaningful information from the stock data run merely in a few seconds for the data of a single security. The total running time to update the information of all the securities of a certain stock market (e.g. HEX) thus requires more time to run because the series of actions described in generic models as in the relevant previous sections have to be repeated for each listed security. That makes circa 190 repetitions in the example case of HEX. By converting the whole implementation to some compiled language like C instead of interpreted language like TCL, running time of the process could decrease with at least two decades. However, the running time of the update is not critical as far as it doesn't take more than a few hours. Even during the update process the server is able to provide one day older information in the normal way and will not replace the information with newly calculated results before the whole update is ready. Thus, the update process is transparent for the clients.

### Manners in which the Process is Utilised

Investor profiles extend from day-trading to the so called ‘buy and hold’ strategy. The day-trading means buying and selling the same shares strictly on one day, even without a profit. The other end, the ‘buy and hold’ strategy, which has been recommended especially for ‘rule-maker’ firms like Microsoft, Nokia, Coca-Cola etc. means buying the shares and keeping them forever and getting advantage of dividends. The fundamental difficulty in the ‘rule-maker’ strategy is that the potential firms should be distinguished when they are still of small or medium size. It is an object of the current invention to provide for a trading assistance method in which, like most of the investors prefer, the trading frequency is settled between these extremes. In the process according to the invention, called Stockmapper, a compromise between the extremes has been set: a high risk profile investor is supposed to target in keeping the shares maximum a quarter of a year and a low risk profile investor is supposed to target in keeping the share minimum a quarter, respectively.

In the method according to the invention an investor is intentionally left with a lot of degrees of freedom when using the service. This is because the main objective of the service is to guide the investor out from the track of poor transactions, i.e. to sell cheap and buy expensive. For a client a sensible way to utilize the service would be to perform the following steps:

Study the background of a list of firms that are of interest for the client and maybe drop the ones which give clear signals that they haven't been very successful lately and won't be that in a foreseeable future.

Choose the desired investor profile. This is a choice of opinion for each investor.

Follow the recommendations given by the StockMapper process for the chosen investor profile daily, concentrating on the chosen list of firms. In practice, at least the following strategies can be used separately or mixed:

Use directly the recommendations as simply as possible, viz. first wait for ‘buy’ recommendation for any of the firms on the chosen list and buy as many lots as wanted. Then, wait for ‘sell’ recommendation and sell all lots.

Use the recommendations for the chosen list of firms more systematically by attempting to buy e.g. one lot each day when the recommendation is ‘buy’. Respectively, attempt to sell e.g. one lot each day when the recommendation is ‘sell’.

Use a custom chosen risk level α. By default, the risk level is now fixed to be 10%, viz. in a balanced stock day 10% of the securities are recommended to be sold, 10% are recommended to be bought and remaining 80% are recommended to be held. If a client thinks that ‘sell’ and ‘buy’ recommendations realize too often or too easily, he can choose a stricter risk level, e.g. 2.5%. Then the quantity to follow will be the P-value: if it is lower than 2.5% for the security under consideration the effective recommendation for this new risk level is ‘buy’, if it is higher than 97.5% then the effective recommendation is ‘sell’; any P-value between 2.5% and 97.5% would then mean ‘hold’.

### Examples of Performance Statistics

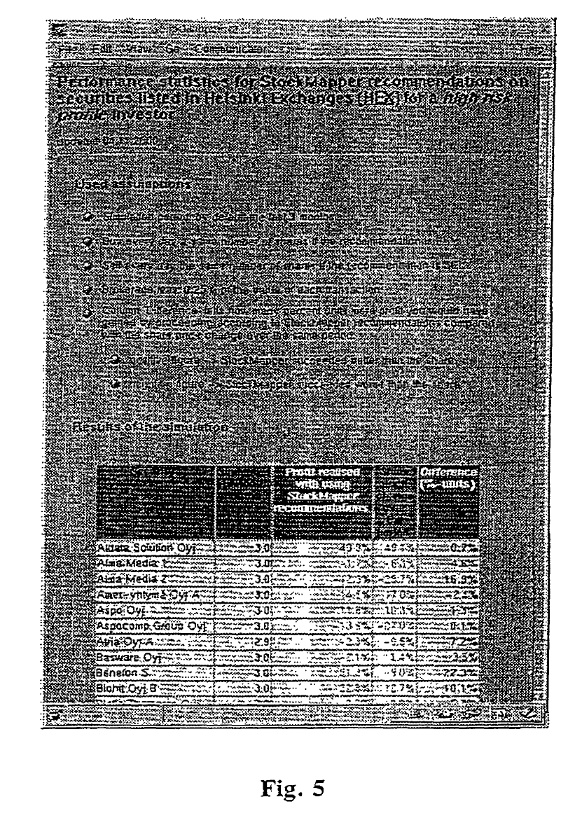

The service has an implementation of one investing strategy in a form of a simulated and daily updated table for both investor profiles and all the securities listed in HEX. These tables are meant to serve as performance statistics of the recommendations. The chosen strategy is the second one in the list of the previous section, viz. it is assumed that the client buys one lot of a share each day when the recommendation is ‘buy’ and sells one lot each day when the recommendation is ‘sell’, respectively. Furthermore, a broker fee of 0.25% of the value of each transaction is assumed to be charged. A screen-shot is provided in FIG. 5.

The performance statistics clearly show that for a big majority of the securities to follow and investing according to the recommendations would result in substantial increase in realized profit when compared with share price change over the simulated period.

For a typical stock day (3.11.2000) of HEX, conclusions of the simulated results were as follows:

For a high risk investor profile and simulation period over the last 3 months period for 170 securities:

The share price change was positive in 54 (31.8%) securities.

The profit realized by acting according to the recommendations was positive in 116 (68.2%) securities.

Both the share price change and the profit realized by acting according to the recommendations were negative in 61 (35.9%) securities.

Both the share price change and the profit realized by acting according to the recommendations were positive in 53 (31.2%) securities.

The share price change was positive and the profit realized by acting according to the recommendations was negative in 1 (0.6%) security.

The share price change was negative and the profit realized by acting according to the recommendations was positive in 55 (32.4%) securities.

The profit when acting according to the recommendations was bigger (or loss smaller) in 147 (86.5%) securities than the share price change.

For a low risk investor profile and simulation period over the last 12 months for 170 securities:

The share price change was positive in 79 (46.5%) securities.

The profit realized by acting according to the recommendations was positive in 131 (77.1%) securities.

Both the share price change and the profit realized by acting according to the recommendations were negative in 39 (22.9%) securities.

Both the share price change and the profit realized by acting according to the recommendations were positive in 79 (46.5%) securities.

The share price change was positive and the profit realized by acting according to the recommendations was negative in none (0.0%) of the securities.

The share price change was negative and the profit realized by acting according to the recommendations was positive in 52 (30.6%) securities.

The profit when acting according to the recommendations was bigger (or loss smaller) in 138 (81.2%) securities than the share price change.

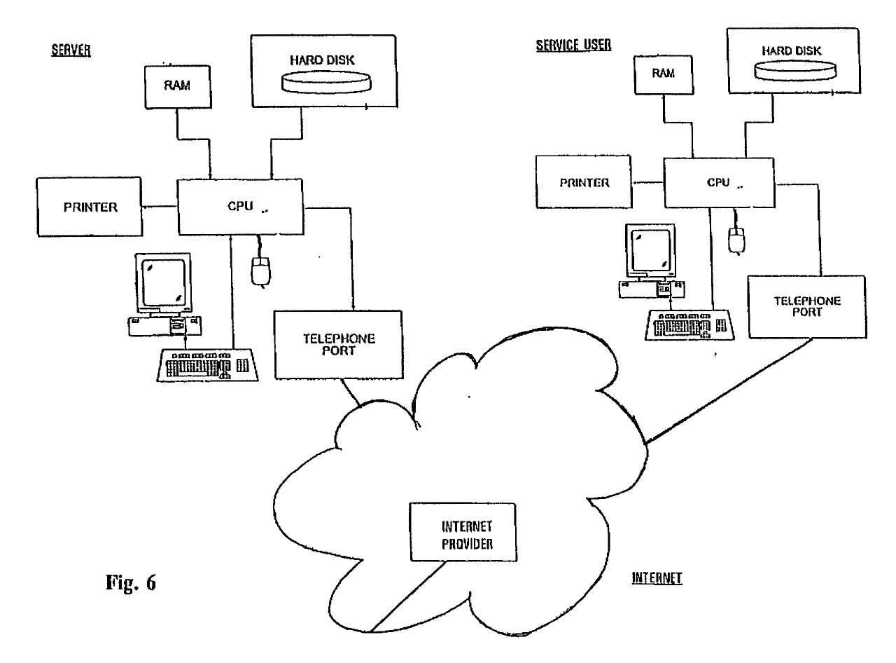

FIG. 6 represents a common computer configuration for a server computer and a client or user computer, each interconnected to one another via a data network, in casu the Internet. The computer program for the method explained in the above is normally stored on the computers hard disk, but may be stored on any other computer readable means. The stock investment recommendation service is run on the server computer and made available to users for normal interaction via the Internet. To this end the Server computer system may be connected to the Internet in a common manner via a so called Internet provider, viz. a separate commonly approachable service run on a separate computer and pertaining further Internet providing means.

The client or user of the stock recommendation service according to the above explained invention has access to the Internet by is own Internet provider, which provider in fact makes available to the service user, the Internet address where the service of the server computer is accessible.

It is intended that the specification and examples be considered exemplary only, with a true scope and spirit of the invention being indicated by the following claims. Thus, the invention apart from all details of the preceding description and pertaining figures, further relates to all features defined in the following claims.

1. A method for aiding stock investors in determining a timing for buying and selling stock securities, including a computer program for collecting and analysing historical stock security data including share price and associated volume data, wherein said data of each security are modelled by said computer program into a probability distribution of historical stock security data, wherein a confidence interval for a security price is determined on the basis of statistical mathematical formulae incorporated in said computer program, and in that said program, on the basis of a comparison between said probability distribution of said historical data and an actual security price provided to said computer program, thereby determining the relative location of said actual price in said probability distribution, provides a recommendation in the form of, at least effectively relating to, one of at least a “buy”, a “sell” and a “hold” recommendation.

2. A method according to claim 1, wherein said probability distribution of said historical stock data of a security is analyzed and modelled in accordance with a wave-like fluctuation of the stock price, having a determined wavelength and amplitude, preferably by the application of a Fast Fourier Transform (FFT) method performed by said computer program.

3. A method according to claim 1, wherein the historical price data of a security are modelled into day prices by a recalculation of lowest and highest prices of a particular day together with opening and closing prices of that day into one effective day price (P_{eff}), each said effective day price (P_{eff}) component being incorporated in said calculation on a predetermined weighing basis.

4. A method according to claim 1, wherein the historical stock data taken into consideration for the purpose of establishing a probability distribution are part of a history window selected backwardly in time from a most recent history point within a larger range of available historical stock security data, the history window being selected by an analysis of the historical security data using spectral analysis, preferably based on a Fourier transform, such that if the security price under consideration has rapid short term fluctuations of larger amplitude than the fluctuations of a long term period, a relatively short history window is automatically selected, whereas if security price fluctuations over a long term period show significantly larger amplitudes than the short term fluctuations do, a relatively long history window is automatically selected.

5. A method according to claim 1, wherein said historical data are modelled into a probability distribution, preferably one of a Gamma and Gaussian distribution, utilising mean and variance results of computer calculations on volume weighed effective day prices (P_{eff}).

6. A computer program stored on a computer readable medium, configured for executing the method according to claim 1.

7. A computer executing, at least set immediately ready for executing, the computer program according to claim 6.

8. A data network service, in particular an Internet service, applying a method according to claim 1 on the basis of a risk level set by a user of said service through a data network interface with a computer program running said method.

9. A data network service according to claim 8, wherein said service is arranged for providing a set of recommendations either directly or indirectly effective towards a selling, buying and holding of a particular stock security.

10. A data network service according to claim 8, wherein required historical security data are updated at least daily, automatically by said computer program, for at least data of one stock exchange.

11. A data network service made available to a public, e.g. a public including potentially interested stock investors, operating in data network service according to claim 8.

12. A data network service relaying means, such as an Internet Provider, including a computer and, in particular, including an Internet providing arrangement, providing, at least relaying the computer program and/or service according to claim 6.

13. A computer arranged for executing a method according to claim 1, for analysing stock data, wherein the following steps are performed periodically in a predetermined frequency, by said computer;
the stock price and volume information of any stock exchange listed securities are downloaded from a data network, e.g. via Internet,
said stock price and volume information is transformed into appropriate numerical data for a statistical calculation thereof,
said downloaded data is appended to a previous gathered data base of stock prices and volumes by said computer,
a history window is determined for statistical modelling for each security of said downloaded data by a Fourier transform based spectral analysis,
a wavelength of a most dominant frequency component as said history window in stock days is selected,
said price and volume data is utilised to determine a probability distribution extending over said history window for each security,
a P-value of the most current security price is calculated on the estimated probability distribution for each security,
confidence limits of one of a predetermined and a true performance statistics history optimized risk level α for each security are determined,
said calculated P-value is utilised to categorize a recommendation of one of at least “buy”, “sell” and “hold” for each security.

14. A computer implemented method according to claim 13, comprising the steps of:
using said confidence limits as an additional information to said recommendation, viz. as “the highest price to buy” and “the lowest price to sell” limits,
producing said calculated values for each security in a format suitable for a relevant representation.

15. A computerised investment timing management system which executes a method according to any of the previous claims, and serves the results in any format the clients' side requests, that can be provided over the Internet.
